(19) United States
(12) Patent Application Publication
(10) Pub. No.: US 2019/0262635 A1
(43) Pub. Date: Aug. 29, 2019

(54) ROOF-ANCHORING DEVICES AND METHODS

(71) Applicant: Flent D. Ballantyne, McKinney, TX (US)

(72) Inventor: Flent D. Ballantyne, McKinney, TX (US)

(21) Appl. No.: 15/906,113

(22) Filed: Feb. 27, 2018

(51) Int. Cl. A62B 35/00; E04G 21/32

(52) U.S. Cl. CPC A62B 35/0068; E04G 21/3276

(57) ABSTRACT

Improved roof anchoring devices, methods, and systems including a connector that is pivotally attached to an axle. A trapezoidal or other shaped stop can be used to keep a wheeled roof anchoring member in place, as needed, during deployment or installation of a roof anchoring system. In a method utilizing an improved anchoring device, an anchoring hook and stop are used together during installation of the anchoring system.

### BACKGROUND

Different types and configurations of anchorages and anchorage systems are well known to be used for fall restraint, fall arrest and rope access; in construction, repair, inspection and other industries. They are configured to prevent injury or death, by restraining a person from falling and/or arresting a fall. They are also used to assist with rope access.

For example, a World Intellectual Property Organization (WIPO) published application WO9949154 filed by BALLANTYNE illustrates a safety system for roof workers comprising roof fixing means adapted to be connected to one edge of a roof along with a harness worn by a roof worker on the opposite side of the roof. A safety rope connects the harness to the roof fixing means. The roof fixing means may be a roof anchor having a hook which hooks to the lower edge of roof cladding (such as metal sheet) or roofing tile. A clamping bolt fixes the roof anchor to the cladding.

U.S. Pat. No. 8,292,030 to BALLANTYNE further teaches an anchoring system wherein the roof fixing means may be a wheeled “hook member” adapted to be mounted to an eave or similar roof structure. Moreover, the hook member in that patent has a tether affixed to the hook body. However, it is possible that the hook can move or become dislodged if the tether attached to the hook body is pulled or otherwise abruptly moved. If the anchoring hook becomes dislodged, a user is vulnerable to the risk of a serious or fatal fall.

Moreover, known prior art systems and mechanisms are viewed as either too complex, time consuming, difficult to apply or causing permanent damage or unattractive modification to at least a portion of the roof.

### SUMMARY

Exemplary improved anchoring devices and systems may include connectors that pivotally attach to the axle of a wheeled anchoring hook. In one embodiment, the anchoring device includes a first axle coupled to a first wheel and second wheel; a second axle coupled to a third wheel and fourth wheel; and an arched member or “hook,” with the arched member coupled to the first axle and the second axle and configured to fit around an eave or similar roof abutment.

Embodiments of improved anchoring devices and systems may further include a connector that is pivotally attached to an axle through an opening and includes at least one other opening to which a tether (or another connector or different device) may be attached. In another embodiment, the connector may include a plurality of openings in addition to the opening used to couple the connector to the axle. In still a further embodiment, the connector goes around the anchoring hook body and attaches to the axle on both sides of the hook body.

Additional embodiments may include the use of a trapezoidal or other shaped member that acts as a “stop” to keep a wheeled roof anchoring member in place, as needed, during deployment or installation of the roof anchoring system. The stop is designed so that a person can remotely remove the “stop” from the roof.

Methods relating to improved anchoring devices also are described herein. In a method embodiment, an anchoring hook can be removed from the stop by pulling the anchoring hook off the stop, using a tether, or tether and connector, or any other means, whereupon the stop falls to the ground.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary perspective view of an improved wheeled roof-anchor or “eave hook” device featuring a connector pivotally attached to an axle;

FIG. 2 is a bottom perspective view of the device in FIG. 1 and shows a clearer view of the connector attached to an axle;

FIG. 3 is a perspective view of the embodiment of the connector depicted in FIGS. 1 and 2;

FIGS. 4A and 4B are a perspective view of a stop member used with a roof anchor such as that depicted in FIGS. 1 and 2.

FIGS. 5A and 5B show a stop member coupled to an anchoring device, and then separating from an anchoring device, respectively.

FIG. 6 depicts in bottom view another connector embodiment that is attached to an axle of an anchoring member in two places (for clarity, the wheels have been removed from the axle).

FIG. 7 shows an example of an anchoring device and a tether that is attached to the main body of the anchoring device. A sudden great force, from the attached tether or connector and tether, as might be expected when a user is falling from the opposite side of a house, is shown to cause the anchoring device to detach from the eave.

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the method, system or apparatus include the discussed feature, advantage or mode of operation.

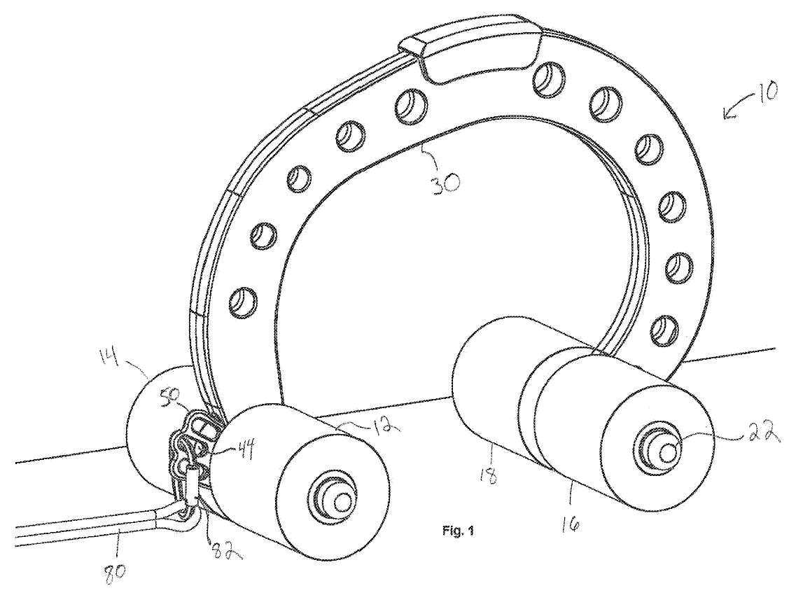

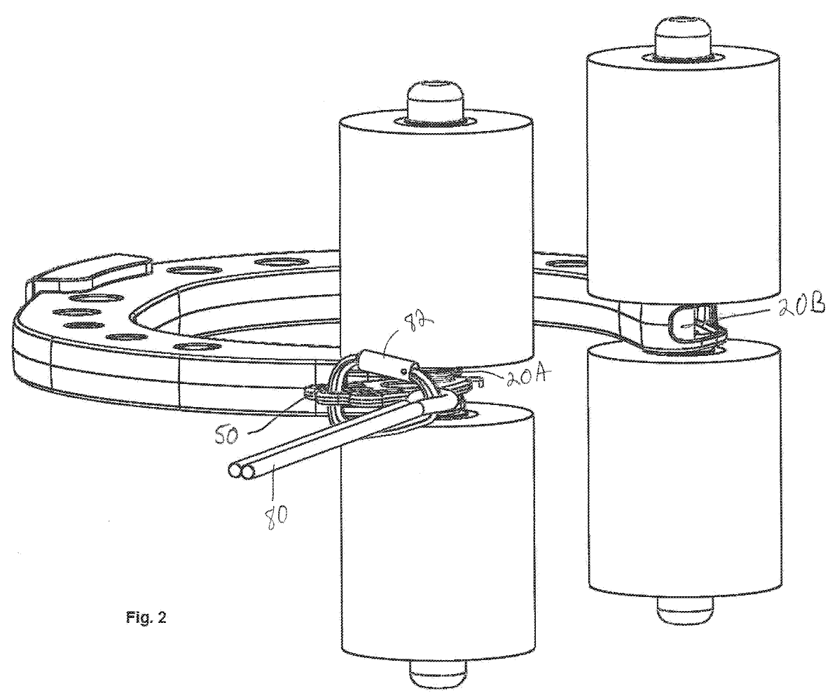

With general reference to exemplary FIGS. 1-2, a wheeled or mobile “eave hook” device or anchor 10 may be shown as having four sets of double wheels 12, 14, 16 and 18. In fact, four sets of more or fewer wheels could be used with equivalent effect. The wheels can be made of any desired materials such as rubber or plastic, and may also have a slide-resistant surface.

Wheel axles 20A and 20B can be capped with caps 22 and interconnected through an arched anchor or hook 30 that extends continuously from axle 20A to axle 20B, forming an open hook, along the arched anchor body 30. The arched anchor or hook 30 may be constructed of any relatively strong material such as steel or the like. Arched anchor or hook 30 may be configured so as to an asymmetrical “C” shape, with one end forming more of a hook shape than the other end. For example, in FIG. 1, the end of arched anchor or hook 30 that attaches to wheel axle 20B (see FIG. 2) has a curvature that forms more of a hook shape than the end attached to wheel axle 20A. Thus, a roof projection, such as a roof eave, can be engaged by the arched anchor or hook 30.

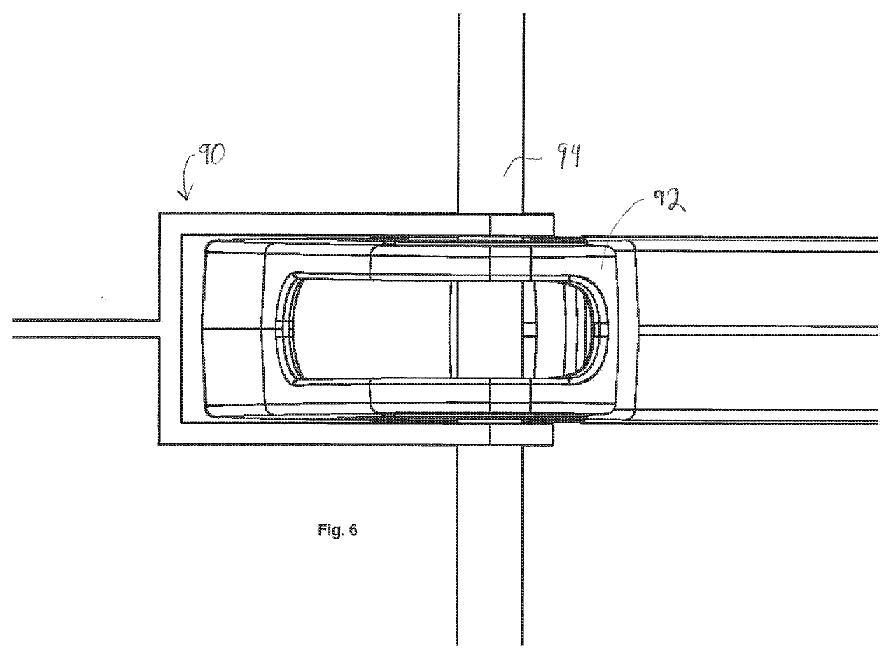

As depicted in FIGS. 1-3, the improved anchoring device further includes a connector 50 that is pivotally attached to an axle (e.g., 20A) through, for example, an opening 60 and includes at least one other opening (e.g., openings 52, 54, and 56) to which a tether (or another connector or different device) may be attached. Alternatively, a connector 90 such as the member shown in FIG. 6, goes around the anchoring device body 92 and attaches in two places on an axle 94 through two openings. As with connector 50, variations on connector 90 are possible such that the connector can include, for example, more than two opens for attachment to an axle as would be the case if the connector is configured in an “M” shape.

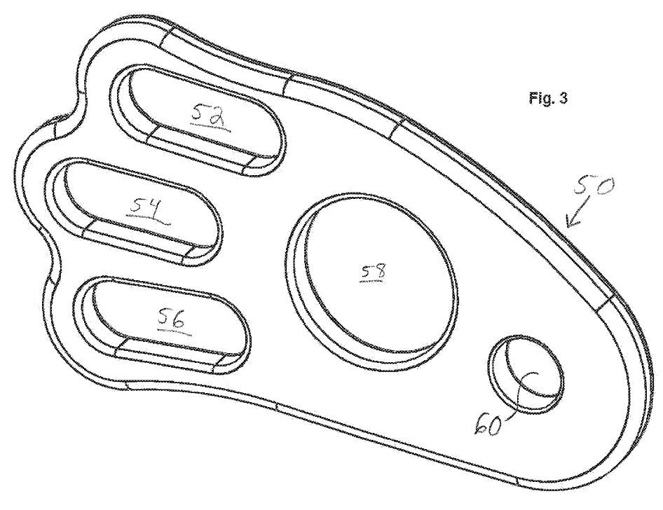

As shown in FIG. 3, the connector 50 may include a plurality of openings (e.g., 52, 54, 56, and 58 in addition to the opening 60, used to couple the connector to the axle. Having multiple openings on the connector facilitates attachment to other connectors, tethers, and other devices that may be used in conjunction therewith.

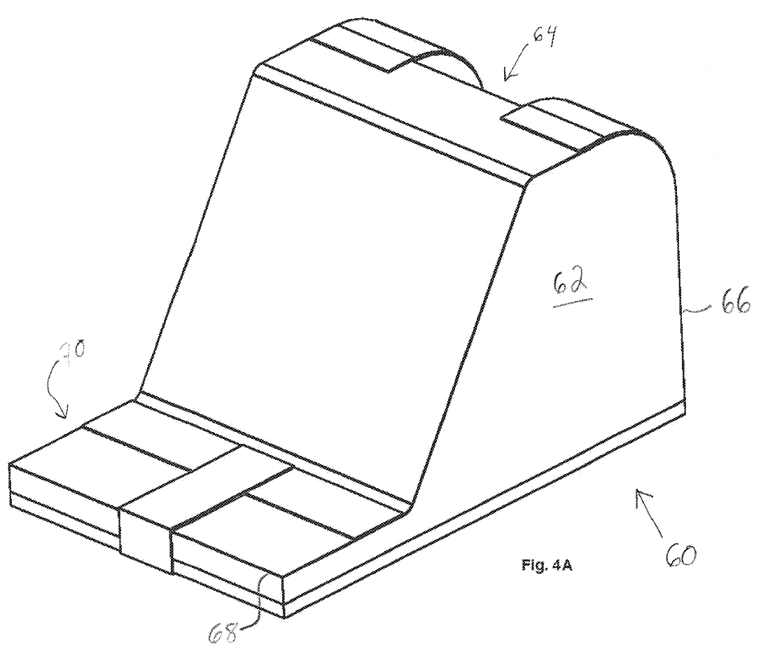

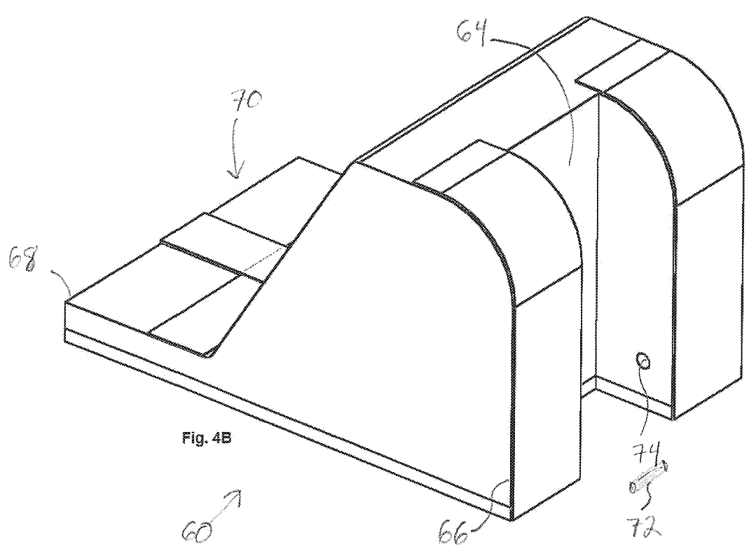

Additional embodiments of the improved anchoring devices include the use of a stop 60, as shown in FIG. 4, to keep a wheeled roof anchoring member in place during deployment or installation of the roof anchoring system. Preferably, as shown in FIGS. 4A and 4B, the stop 60 features a trapezoidal, wedge-shaped portion, or other appropriate shape 62, to prevent the mobile device from descending the roof. The stop further may feature a notch 64 on a first end 66 and a planar or other appropriate shape 70, on a second end 68, upon which the wheels of the wheeled anchor may sit. In addition, a rod 72 may be inserted into the opening 74 of the stop, or otherwise be attached to the stop with, for example, a clamp, and used as a handle or connection point for a tether, carabiner, snap hook or other device and/or to add counterweight (e.g., if a steel rod is used) so that the stop will remove itself (fall from the roof) when it needs to be removed. This allows a user to safely remove the stop (e.g., the user can remove the “stop” while standing on the ground).

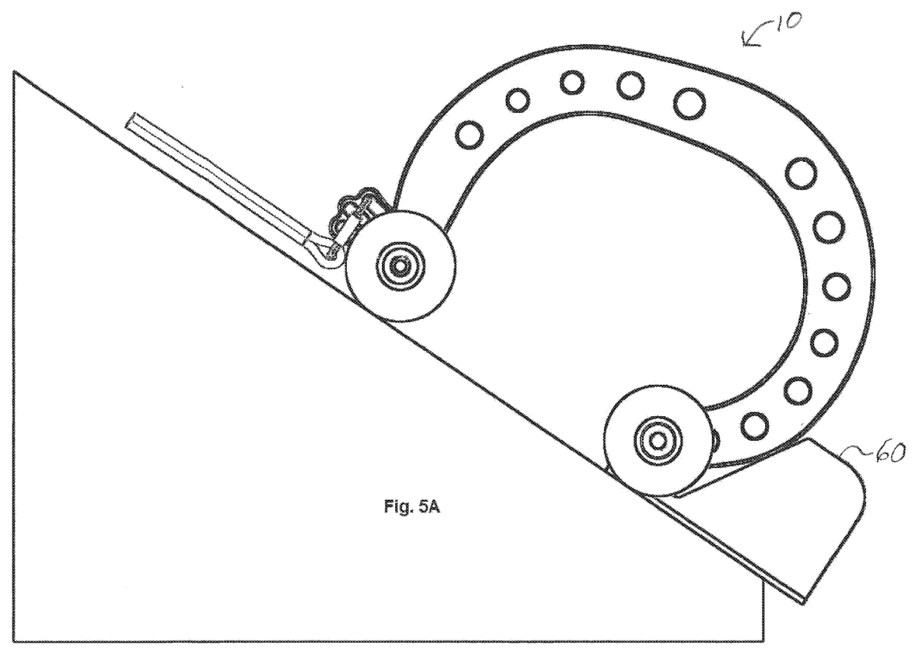

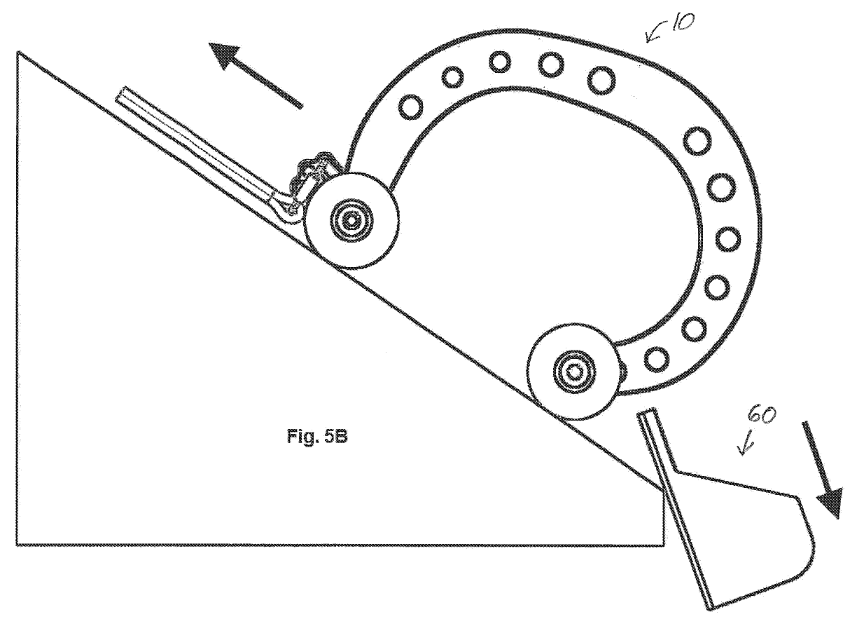

FIGS. 5A and 5B depict a stop embodiment 60 in use with an anchoring member, with 5A showing the two coupled together while 5B shows the “release” of the stop when a user desires to position the anchoring member 10 on an eave or other structure.

Methods and systems relating to improved anchoring devices also are described herein. Additionally, the eave hook devices may be formed in any size. For example different sizes of eave hook devices may be desirable when using with projections or eaves of different size. Moreover, stops of the invention can have different shapes other than those described above.

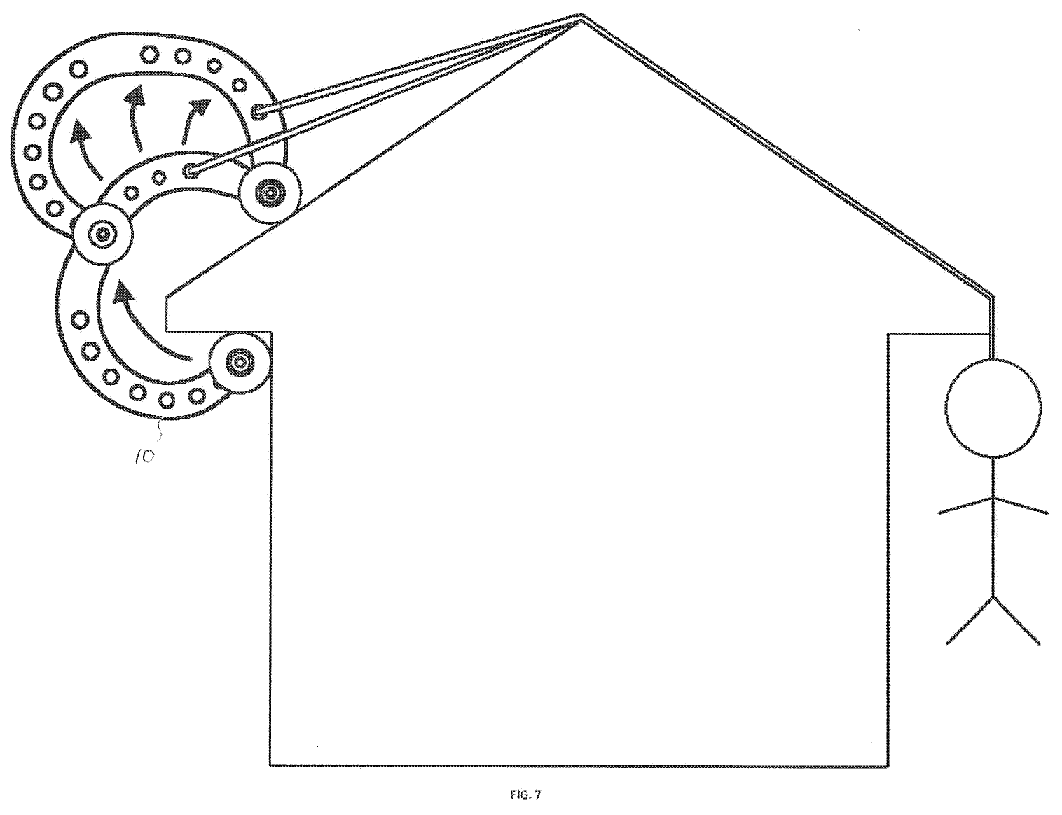

As shown in FIGS. 1 and 2, a rope 80 (tether) or the like, may be coupled with anchoring hook device 10. In this example, tether line 80 may be coupled to a snap hook, carabineer, or similar connector 82, which is then connected to the pivotally attached connector 50. However, it may also be desirable to couple rope 80 directly to connector 50 without the use of intermediary connectors and the like. Analysis has shown that utilizing a pivotal connector, attached to an axle, on one side and a tether or further connector and tether, on the other side, allows a greater force, as would be expected if a fall occurs, to be placed on the device 10, without the risk of pulling or otherwise dislodging it away from being secured to an eave or similar structure (see FIG. 7, which illustrates device 10 being dislodged when a tether is attached to the anchoring device body instead of an axle). Such a failure of the anchoring device can result in injury or death.

After a user (not pictured) ensures that the anchoring hook device 10 and tether line 80, FIGS. 1 and 2, are securely attached in place at the pivotally attached connector, the user may proceed to lower anchoring hook device 10 down a roof slope or similar from a roof ridge or peak (not pictured). As the wheeled anchoring hook device 10 reaches the roof edge, the leading wheels 16 and 18 of the device 10 may drop below the roof edge. The anchoring hook device 10 may then swing inwardly below the roof edge to engage a soffit or under-roof surface (not pictured). Then the anchoring hook device 10 may be tensioned or pulled by the tether line 80 so as to draw it tightly into place, while the trailing wheels 12 and 14 (at the device 10 tethered end) remain on the roof surface above the lower wheels

When used with a “stop”, an installation method involves the steps of positioning a wheeled anchoring hook device 10 near the roof edge, with the leading wheels 16 and 18 resting upon or otherwise engaging a stop. When the user is ready to install the device 10, wheels 16 and 18 are removed/disengaged from the stop 60, whereupon the stop falls to the ground. Then, the leading wheels 16 and 18 of the device 10 may drop below the roof edge such that the anchoring hook device 10 is swung inwardly below the roof edge to engage a soffit or under-roof surface (not pictured).

It should be evident that the improved anchoring device 10, system and any components disclosed herein may be fabricated or formed in a variety of ways and from a variety of materials. The various parts may be machined, molded or otherwise fabricated from high strength materials such as steel, aluminum alloy, reinforced aluminum, tubular alloy, high-strength plastics or wood, or be manufactured from a combination of any suitable materials and processes. The choice of materials and construction are clearly within the scope of the appended claims.

The foregoing description and accompanying drawings illustrate principles, preferred embodiments and modes of operation of the invention. However, the invention should not be construed as being limited to the particular embodiments discussed above. Additional variations of the embodiments discussed above will be appreciated by those skilled in the art. Therefore, the above-described embodiments should be regarded as illustrative rather than restrictive. Accordingly, it should be appreciated that variations to those embodiments can be made by those skilled in the art without departing from the scope of the invention as defined by the following claims.

I claim:

1. An anchoring device comprising an arched or hook body coupled to a first axle and a second axle, said first axle being coupled to a first wheel and second wheel and said second axle being coupled to a third wheel and fourth wheel, wherein
a connector or connectors is/are pivotally attached to at least one of said first axle and said second axle.

2. The anchoring device of claim 1, wherein said arched or hook body is more curved at a first end and said connector is pivotally attached to said axle at second end.

3. The anchoring device of claim 1, wherein said connector includes at least two openings.

4. The anchoring device of claim 1, wherein said connector comprises at least three openings and is configured to pivotally engage said axle in two places.

5. The anchoring device of claim 1, wherein said connector with at least three openings is configured to go around to the sides of the body of the anchoring device and attaches to an axle of the anchoring device through at least two of said at least three openings.

6. A roof anchoring system comprising:
an anchoring device comprising an arched or hook body coupled to a first axle and a second axle, said first axle being coupled to a first wheel and second wheel, and said second axle being coupled to a third wheel and fourth wheel, wherein the arched or hook body is coupled to a connector that is pivotally attached to at least one of said first axle and said second axle; and
a stop that blocks the wheeled anchor from moving downwardly from a roof.

7. The system of claim 6, wherein the stop comprises a trapezoidal, triangular, or wedge-shaped portion.

8. The anchoring system of claim 6, wherein said stop further comprises a notch on said first end and a planar portion on which the wheels of the wheeled anchor may be disposed on said second end of the stop.

9. The anchoring device of claim 6, wherein said stop comprises a trapezoidal, triangular, or wedge-shaped portion and a notch on a first end and a planar portion on a second end of the stop.

10. The anchoring system of claim 8, further including a counter weight at said first end.

11. The anchoring system of claim 9, further including a counter weight configured to be inserted or attached to the first end of the stop.

12. A roof anchor installation method, comprising the steps of:
positioning a wheeled roof anchoring device near a roof edge; and engaging said device with a stop located between said device and said roof edge.

13. The method of claim 12, further including the step of disengaging the device from the stop such that the stop falls from said roof edge.

14. The method of claim 12, wherein said stop comprises a trapezoidal, triangular, or wedge-shaped portion.

15. The method of claim 12, wherein said stop further comprises a notch on a first end and a planar portion on a second end of the stop.

16. The method of claim 12, wherein said stop further comprises a planar portion at a second end of the stop.

17. The method of claim 12, wherein the stop further includes a counter weight at a first end of said stop.

18. The method of claim 12, wherein the stop further includes a counter weight configured to be inserted or attached to a first end of the stop.

19. The method of claim 12, wherein said arched or hook body is more curved at a first end and a connector is pivotally attached to said axle at a second end of said arched or hook body.

20. The method of claim 12, further comprising a connector pivotally attached to an axle of said anchoring device.
